(19) United States
(12) Patent Application Publication
(10) Pub. No.: US 2007/0055999 A1
(43) Pub. Date: Mar. 8, 2007

(54) METHOD AND SYSTEM FOR INITIATING, CONTROLLING AND MANAGING A CONTENT-ON-DEMAND SESSION VIA PHONE, MOBILE COMMUNICATION OR INTERNET BASED SERVICES

(75) Inventors: BENNY RADOM, Tel Aviv (IL); Ori Zaltzman, Herzelia (IL)

Correspondence Address: FLEIT KAIN GIBBONS GUTMAN BONGINI & BIANCO, 21355 EAST DIXIE HIGHWAY, SUITE 115, MIAMI, FL, 33180, US

(73) Assignee: LOOPTV, New York, NY (US)

(21) Appl. No.: 11/470,275

(22) Filed: Sep. 6, 2006

Related U.S. Application Data
(60) Provisional application No. 60/714,349, filed on Sep. 7, 2005.

(51) Int. Cl. G06F 13/00; G06F 3/00; H04N 7/173; H04N 7/16; H04N 5/445

(52) U.S. Cl. 725/86; 725/87; 725/61; 725/62; 725/113; 725/110

(57) ABSTRACT

A system and method providing end-user with an alternative way to initiate and control Content-On-Demand and Video-On-Demand sessions other than by using the dedicated equipment supplied by the COD or VOD service provider. An alternative return channel may be in the form of communication services such as SMS, WAP, telephone based IVR, live human service or Internet based services. Thus, users who lack the bi-directional communication ability or whose COD equipment or system are temporarily or permanently defected may still use Content-On-Demand services.

### FIELD OF THE INVENTION

The present invention relates generally to Content On Demand systems and more particularly to a system and method that enable users to initiate and control Content On Demand sessions using a variety of communication terminals such as a mobile phone, a line phone or the Internet.

### BACKGROUND OF THE PRIOR ART

Content On Demand (COD) services and in particular Video On Demand (VOD) services have become in recent years important elements in the home entertainment arena. When the term COD is used hereinafter, if not otherwise specifically stated, it should be noted that it includes VOD as well. COD sessions are characterized in their enhanced interactivity and may include any form of multimedia session such as a video file, an audio file, an interactive computer game and the like.

In order to provide the user with said interactivity, COD infrastructure generally requires a bi-directional communication channel between the end-user and the COD service provider. The incoming channel from the COD service provider to the end-user is used for audio and video data delivery whereas the return channel from the end-user to the COD service provider is used for initiating and controlling the COD session. COD controls usually include VCR/DVD-like functionality such as play, stop, pause, fast forward, reverse, slow forward, scan, zoom-in, zoom-out, subtitles etc. The return channel may also be used for authentication and payment purposes.

Current bi-directional COD systems use the return channel to activate the COD session and for user authentication. The process of establishing a COD session includes the tuning of the multimedia user terminal or Set-Top-Box so that it may access the COD session that is being transmitted to it.

The return channel is usually implemented in current COD and VOD systems over an existing cable-TV (CATV) wiring (using standards such as DOCSIS, DVB-RC), Internet infrastructure, fiber-to-the-home: DSL, or public switched telephone network (PSTN) data modems.

The basic problem deriving from the above-mentioned implementations is that end-users lacking the specific equipment that supports said COD return channel are unable to use COD services. Similarly, users whose return channel equipment is defected either temporarily or permanently are also unable to use these services.

### SUMMARY OF THE INVENTION

The present invention solves the problem of a non existing return channel, be it a COD infrastructure having only unidirectional communication from the COD service provider to the end user or a faulty bi-directional COD system. This is done by providing a plurality of alternative and independent return channels that are supplementary and unrelated to the incoming channel (i.e., from the COD provider to the end user). These alternative return channels allow the users to initiate a Content-On-Demand session and control it in real-time in several manners including: Short Messaging Services (SMS), Wireless Application Protocol (WAP), Interactive Voice Response (IVR), live human service or Web-based services over the Internet.

Specifically, the present invention describes a system for initiating and controlling a Content On Demand (COD) session transmitted from a multimedia service provider to a multimedia user terminal through a designated network, said system comprising a COD control unit enabling a user to exchange encoded data with said multimedia service provider through a communication channel, wherein said communication channel is supplementary to said designated network and is available for transmitting control data, wherein said encoded data enable the user to control said COD session in accordance with said multimedia service provider requirements.

Additionally, a method for initiating and controlling at least one Content On Demand (COD) session provided by a multimedia service provider through a designated network is disclosed. The method comprises two steps: first, enabling a user to exchange encoded data with said multimedia service provider through a communication channel supplementary to said designated network. Then, and subsequently, responding to said encoded data sent by user over said communication channel and delivering COD sessions to multimedia user terminal over said designated network in accordance with said encoded data.

### BRIEF DESCRIPTION OF DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 depicts a block diagram of a communication system for initiating and controlling at least one COD session;

FIG. 2 is a flow diagram depicting a method for initiating and controlling at least one COD session wherein access codes are entered by the user; and

FIG. 3 is a flow diagram depicting a method for initiating and controlling at least one COD session wherein access codes are transmitted directly to the processing unit.

The drawings together with the description make apparent to those skilled in the art how the invention may be embodied in practice.

No attempt is made to show structural details of the invention in more detail than is necessary for a fundamental understanding of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF SOME EMBODIMENTS OF THE INVENTION

An embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”. “some embodiments” or “other embodiments” means that a particular feature, structure, or characteristic described in connection with the embodiments is included in at least one embodiments, but not necessarily all embodiments, of the inventions.

It is understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

The phrase “consisting essentially of”, and grammatical variants thereof, when used herein is not to the construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” refers to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

The terms “bottom”, “below”, “top” and “above” as used herein do not necessarily indicate that a “bottom” component is below a “top” component or that a component that is “below” is indeed “below” another component or that a component that is “above” is indeed “above” another component. As such, directions, components or both may be flipped, rotated, moved in space, placed in a diagonal orientation or position, placed horizontally or vertically or similarly modified. Accordingly, it will be appreciated that the terms “bottom”. “below”, “top” and “above” may be used herein for exemplary purposes only, to illustrate the relative positioning or placement of certain components, to indicate a first and a second component or to do both.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

The present invention discloses a system and a method for providing end-users with an alternative way to initiate and control COD sessions other than by using the dedicated equipment supplied by the COD service provider. In particular, the present invention suggests using alternative communication data transmitting services such as SMS, WAP, phone based IVR or Internet based services (all of which hereinafter related as ‘communication user terminals’) to serve as a return channel from the end user to the COD service provider.

Specifically, the present invention describes a system for controlling a multimedia session between a user terminal and a remote multimedia service provider through a designated network, wherein said multimedia service provider provides content on demand (COD) services. The said system comprising a COD control unit which provides the user the ability to exchange encoded data through a communication channel other than the designated network, wherein the encoded data enable the user to control the COD sessions relating the COD services.

Additionally, a method for initiating and controlling at least one Content On Demand (COD) session provided by a multimedia service provider through a designated network is disclosed. The method comprises two steps: first, enabling a user to exchange encoded data with said multimedia service provider through a communication channel supplementary to said designated network. Then, and subsequently, responding to said encoded data sent by user over said communication channel and delivering COD sessions to multimedia user terminal over said designated network in accordance with said encoded data.

According to some embodiments of the invention, once the system identifies a technical failure in the COD return channel communications, it provides the user with activation codes and operation instructions and presents them on the multimedia user terminal. The user in turn is able to act according to said instructions and transmit the activation codes to the COD service provider using one of the above mentioned communication user terminals.

According to other embodiments of the invention, the user lacks the COD dedicated hardware that helps establishing a return channel. Therefore, the system provides the user with activation codes and operation instructions presented on the multimedia user terminal.

It should be noted that the term ‘presented’ in this application relates to any manner of supplying a user with data or information concerning the COD session. Thus, said data and information presentation may take the form of any audio and/or visual means, displays or live human service offered over the phone such as a call center.

According to one embodiment of the invention, a user authentication feature will be provided with the system. The user may use any of the communication user terminals to enter one or more codes. These codes may include user identification data, user location data, a multimedia asset identification data (File ID), time reference, expiration time and the like. Subsequently, the system may authenticate the user, check for user billing data, credit information, parental control and other features. Upon processing the above mentioned data the system may approve or reject the user's transaction.

According to some embodiments of the invention, upon user approval, the system contacts the COD service provider and passes the necessary data to initiate session transmission. The system then produces and sends back access codes to the user via the user communication terminal. The multimedia service provider then establishes a COD session for the end-user. After the user enters said access codes using a processing unit (such as a Set-Top-Box), an access process may authenticate the codes, extract the tuning information and tune accordingly to enable viewing of the COD session.

According to other embodiments of the invention, the system produces the access codes and transmits them periodically over the broadcast stream to a processing unit (such as a Set-Top-Box). The processing unit may authenticate the access codes, extract the tuning information and tune the system accordingly to enable viewing of the COD session.

According to one embodiment of the invention, the system may batch together multiple recent access codes in one file to be transmitted to some or all multimedia user terminals (i.e. broadcast configuration). The number of access codes, time frame and total file size parameters may be determined by the operator of the system and/or the service provider.

According to other embodiments of the invention, upon initiating a COD session as described above, the user is enabled to control said session in real time through any of the communication user terminals. In particular, the user is provided with VCR/DVD-like functionalities such as: play, stop, pause, fast forward, reverse, slow forward, scan, zoom-in, zoom-out, subtitles and the like.

According to one embodiment of the invention the system may be connected to at least one billing systems and/or customer service systems associated with the COD service provider.

According to one embodiment of the invention the system may provide the user with a unique temporary shorter session authentication codes that may be used later for controlling said session.

According to one embodiment of the invention the system may employ encryption and hashing protocols to secure the information, enforce expiration date, authenticate the user and validity of the activation and access codes.

According to one embodiment of the invention the encryption may be based on time reference, shared-key, end-user identifiers (such as customer ID, equipment ID, public/private keys), asset ID and asset type.

According to one embodiment of the invention the system may request a personal identification number (PIN). Said PIN may be used to authenticate purchasing content or for parental control purposes (e.g. for ordering adult content by using a different parental control code).

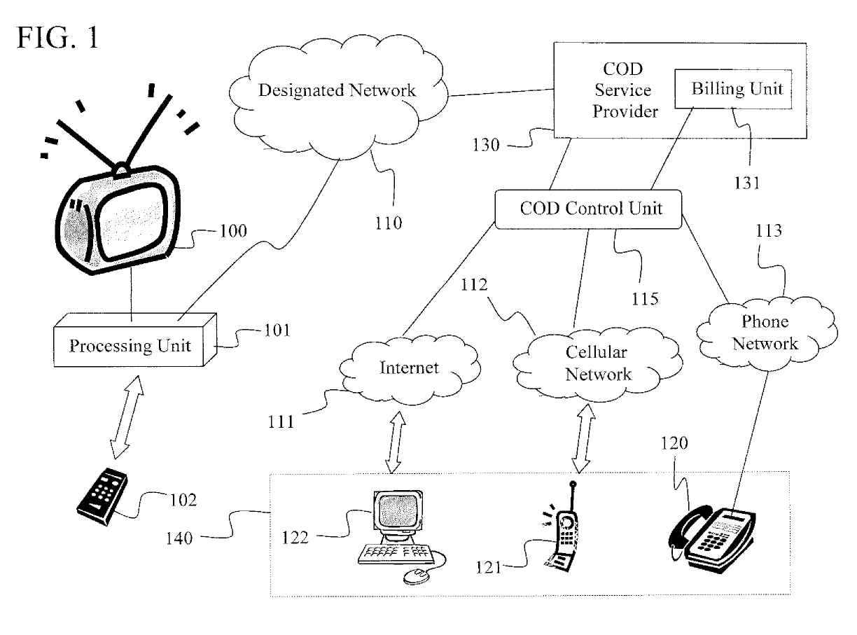

Referring now to FIG. 1, the environment of the present invention is depicted according to one embodiment of the invention. The environment comprises of: a multimedia user terminal 100 with a processing unit 101 such as a Set-Top-Box and a remote control 102; a multimedia network 110, the Internet network 111, a cellular network 112 and a public telephone network 113; communication user terminals 140 such as: a telephone 120, a mobile phone 121 and a PC 122; an COD control unit 115; a COD service provider 130 and a billing/customer service system 131.

The general operation of the system is as follows: The system identifies that the dedicated COD hardware/software is faulty or that it is non-existing altogether and present the user with an activation code relevant to the content request together with contact instructions. For security reasons, said activation code may be encrypted and may be targeted to one or more device or customer. The user sends a COD request by entering said activation code using SMS or WAP services on the mobile phone 121, using IVR or a calling center on the telephone 120 or using web-based service on the PC 122 or any device with Internet capabilities. Said codes is transferred to the COD service provider 130 and conveyed by the COD control unit 115 via the cellular phone network 112, public telephone network 111 or the Internet network 113 respectively.

The COD control unit 115 is a designated gateway server which is programmed in accordance with the present invention's methodology to manage and control the communication between the multimedia service provider and the different communication networks.

Subsequently, the multimedia service provider 130 receives user data, processes it and may reject or approve the COD session request. The multimedia service provider 130 may exchange user data to billing/customer service system 131. The COD control unit 115 may authenticate and/or update and/or retrieve user data with billing/customer service system 131. The multimedia service provider 130 may start transmitting the requested content and may delay the beginning of the playback for a specified time period. The COD control unit 115 then generates and transmits access codes to the user and delivers them on the communication user terminal 140. The access codes may be encrypted and may be targeted to one or more Processing Units 101. The access codes may include access information of the requested COD. The multimedia service provider 130 establishes a COD session on a specific available channel over the multimedia network 110. The user is then required to enter the access codes on the multimedia user terminal. The user may interact with multimedia user terminal 100 and/or processing unit 101 using a remote control 102. In another embodiment if this invention, the access codes are transmitted through the multimedia network 110 to the processing unit 101 without user interaction. The Processing Unit 101 then verifies the codes and may access the COD session accordingly to allow viewing.

While the COD session is being delivered, the user is able to use any of the communication user terminals 140 to control the ongoing COD session. For example, a user may choose a mobile phone 121 as his or her communication user terminal. The user may be presented with a GUI menu over a WAP session for controlling the COD session. Thus, a WAP session is active along the COD session. The user may control the COD session by pressing ‘1’ for ‘play’ ‘0’ for ‘stop’, ‘2’ for fast forward’ ‘3’ for ‘reverse’ etc. Similarly, the user may send control codes via SMS. Another example is a dedicated website for COD session controlling such a website may have a fully functioning virtual remote control and the user may use this virtual remote control for controlling the COD session.

The Multimedia user terminal 100 may also display a short unique session identifier to the user allowing an easier authentication means for controlling the COD session using communication terminals 140. COD session may be also identified using unique properties of the communication user terminals 140 such as phone number/caller ID, IP address and session cookies.

According to other embodiments of the invention, the user may also call a live human service offered over the phone such as a call center that will process the said activation codes and produce corresponding access codes.

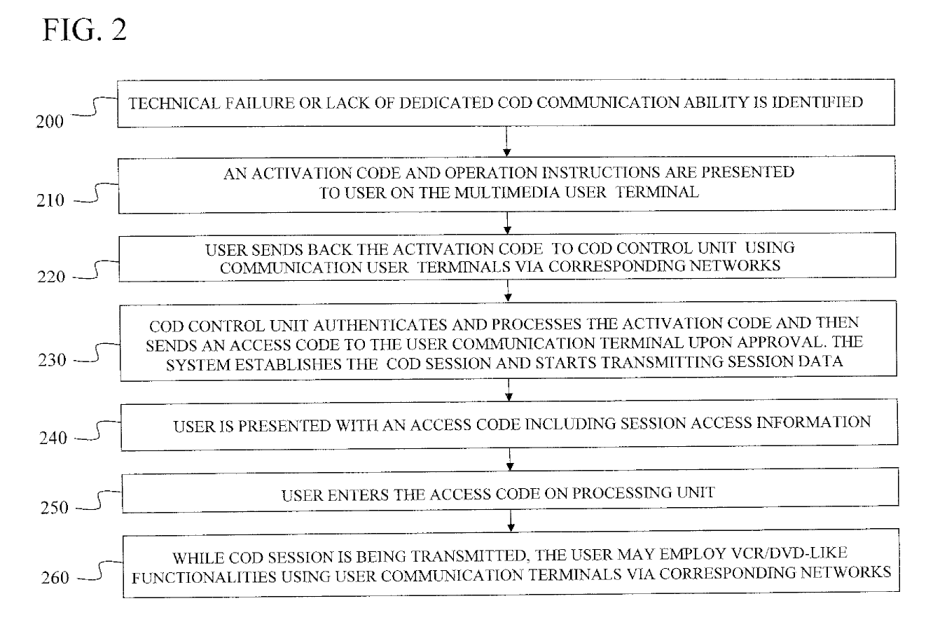

Turning now to FIG. 2 a flow diagram is showing a method for initiating, controlling and managing at least one COD session. During initialization, a technical failure or lack of dedicated COD communication ability is identified 200. Subsequently, an activation code and operation instructions are presented to the user on the multimedia user terminal 100, 210. The user then sends back activation codes to the multimedia service provider 130 through the COD control unit 115 using communication user terminals 140 via corresponding networks 220. The COD control unit 115 authenticates and processes the activation code and then sends an access code to the user communication terminal upon approval, The system establishes the COD session and starts transmitting session data 230. The user is presented with an access code including session access information 240. The user enters the access code on processing unit 250. The Processing Unit 101 processes and authenticates the access codes and tunes the multimedia user terminal 100 accordingly to allow access to the COD. While the COD session is being transmitted, the user is able to employ VCR/DVD-like functionalities using any of the communication user terminals 140, 260.

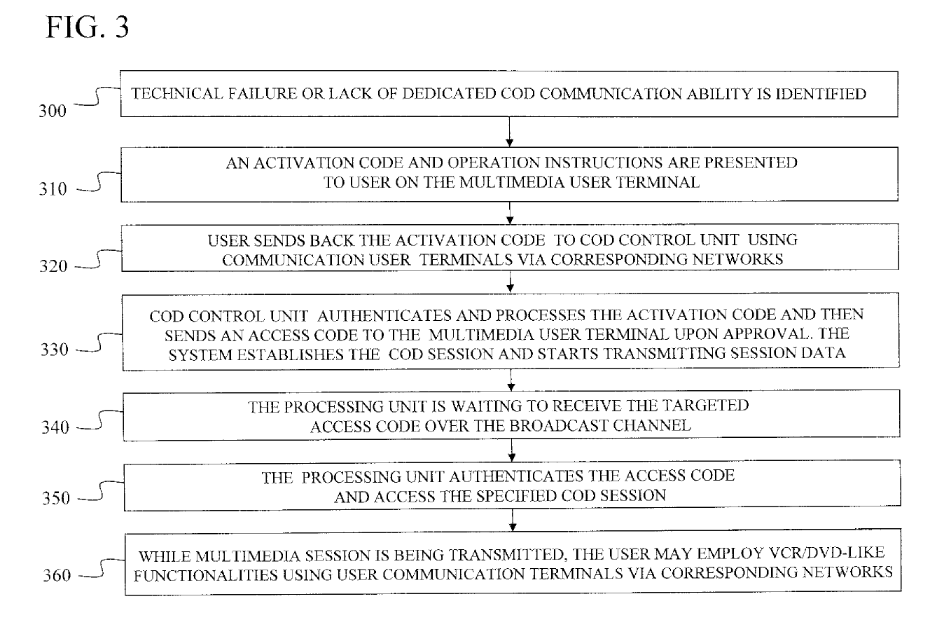

Turning now to FIG. 3, a flow diagram is showing a slightly different embodiment for a method for initiating, controlling and managing at least one COD session. During initialization, a technical failure or lack of dedicated COD communication ability is identified 300. Subsequently, an activation code and operation instructions are presented to the user on the multimedia user terminal 100, 310. The user then sends back activation codes to the multimedia service provider 130 through the COD control unit 115 using communication user terminals 140 via corresponding networks 320. The COD control unit 115 authenticates and processes the activation code and then sends an access code to the multimedia user terminal upon approval. The system establishes the COD session and starts transmitting session data 330. The processing unit 101 is waiting to receive the targeted access code over the broadcast channel, 340. The processing unit 101 authenticates the access code and access the specified COD session 350. While the COD session is being transmitted, the user is able to employ VCR/DVD-like functionalities using any of the communication user terminals 140, 360.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A system for initiating and controlling a Content On Demand (COD) session transmitted from a multimedia service provider to a multimedia user terminal through a designated network, said system comprising:
a COD control unit enabling a user to exchange encoded data with said multimedia service provider through a communication channel, wherein said communication channel is supplementary to said designated network and is available for transmitting control data, wherein said encoded data enable the user to control said COD session in accordance with said multimedia service provider requirements.

2. The system according to claim 1, wherein said COD control unit is embedded within said multimedia service provider.

3. The system according to claim 1, wherein said multimedia user terminal is coupled to a processing unit and wherein said processing unit is configured to set said multimedia user terminal for receiving said COD session in accordance with said COD control unit.

4. The system according to claim 3, wherein said processing unit is embedded within said multimedia user terminal.

5. The system according to claim 3, wherein said processing unit is a set-top-box.

6. The system according to claim 3, further comprising at least one communication user terminal configured to communicate with said COD control unit via said communication channel.

7. The system according to claim 6, wherein said communication channel is one of the following: a cellular network, a public phone network, the Internet network, a Digital Subscribe Line (DSL), a Very Small Aperture Transceiver (VSAT), a live human service offered over the phone.

8. The system according to claim 6, wherein said communication user terminal is one of the following: a phone, a mobile phone, a computer, a personal device accessory (PDA), an Internet enabled communication device.

9. The system according to claim 6, wherein the user is presented with an activation code over said multimedia user terminal whenever a COD session is requested by said user and a failure to transmit said COD session request is identified by a processing unit and wherein the user is required to enter said activation code on said communication user terminal for transmission to said COD control unit over said communication channel.

10. The system according to claim 9, wherein said activation code hold encrypted data related to at least one of the following: COD session identification data, multimedia user terminal identification data, processing unit identification data, user identification data, user location data, multimedia asset identification data, file ID, time reference, user account, expiration time.

11. The system according to claim 9, wherein said activation code is a sequence of numbers and characters that may be easily entered on said communication user terminal by the user.

12. The system according to claim 10, wherein said system further comprises a billing unit, wherein said billing unit authenticates user by matching information decrypted from said activation code with information held within said multimedia service provider, and wherein said billing unit enables payment transfer between user and said multimedia service provider in accordance with predefined terms and the COD sessions requested.

13. The system according to claim 12, wherein said billing unit is embedded within said COD control unit.

14. The system according to claim 9, wherein the user is presented with an encrypted access code over the multimedia user terminal, in response to the transmission of said activation code and wherein said access code holds the information required for the multimedia user terminal to start receiving said COD session.

15. The system according to claim 9, wherein said user is enabled to use said communication user terminal to employ VCR/DVD-like functionalities over said COD session.

16. The system according to claim 15, wherein said VCR/DVD-like functionalities include one of the following: play, stop, pause, fast forward, reverse, slow forward, scan, zoom-in, zoom-out, subtitles, audio, angle.

17. The system according to claim 15, wherein quick identification of the user employing said VCR/DVD functionalities is achieved by identifying said communication user terminal by at least one of the following: IP address, cookie, short session identifier, caller ID, WAP session.

18. The system according to claim 17, wherein said quick identification is time limited and expires when the COD session expires.

19. The system according to claim 16, wherein said VCR/DVD functionalities are offered on a cellular phone over a WAP environment.

20. The system according to claim 16, wherein said VCR/DVD functionalities are offered over an SMS platform wherein predefined numbers correspond with said VCR/DVD functionalities.

21. The system according to claim 16, wherein said VCR/DVD functionalities are offered over an IVR service wherein predefined numbers correspond with said VCR/DVD functionalities.

22. The system according to claim 16, wherein said VCR/DVD functionalities are offered on an Internet website.

23. A method for initiating and controlling at least one Content On Demand (COD) session provided by a multimedia service provider through a designated network, said method comprising the following steps:
(a) enabling a user to exchange encoded data with said multimedia service provider through a communication channel supplementary to said designated network;
(b) responding to said encoded data sent by user over said communication channel and delivering COD sessions to multimedia user terminal over said designated network in accordance with said encoded data.

24. The method according to claim 23, wherein step (a) is preceded by identifying one of the following: lack of dedicated COD communication ability, technical failure thereof.

25. The method according to claim 24, wherein step (b) is preceded by presenting user with an activation code comprising encrypted information relating to at least one of the following: COD session identification data, multimedia user terminal identification data, processing unit identification data, user identification data, user location data, multimedia asset identification data, file ID, time reference, user account, expiration time.

26. The method according to claim 25, wherein presenting user with an activation code is followed by enabling user to enter said activation code on a communication user terminal.

27. The method according to claim 25, wherein enabling user to enter said activation code on a communication user terminal is followed by presenting the user with access code comprising information required to set said multimedia user terminal to receiving said COD session.

28. The method according to claim 25, wherein enabling user to enter said activation code on a communication user terminal is followed by delivering an access code directly to the processing unit and setting said processing unit to receiving said COD session.

29. The method according to claim 28 wherein said processing unit is embedded within said multimedia user terminal.
